(19) United States
(12) Patent Application Publication
(10) Pub. No.: US 2025/0056294 A1
(43) Pub. Date: Feb. 13, 2025

(54) TECHNIQUES FOR INTELLIGENT CHANNEL PREDICTION AND TRANSMISSION OF INFORMATION THEREOF IN WIRELESS COMMUNICATION SYSTEM

(71) Applicant: Electronics and Telecommunications Research Institute, Daejeon (KR)

(72) Inventors: Yong Jin KWON, Daejeon (KR); Seung Jae BAHNG, Daejeon (KR); An Seok LEE, Daejeon (KR); Hee Soo LEE, Daejeon (KR); Yun Joo KIM, Daejeon (KR); Hyun Seo PARK, Daejeon (KR); Jung Bo SON, Daejeon (KR); Yu Ro LEE, Daejeon (KR)

(21) Appl. No.: 18/799,759

(22) Filed: Aug. 9, 2024

(30) Foreign Application Priority Data
Aug. 11, 2023 (KR) 10-2023-0105760
Mar. 21, 2024 (KR) 10-2024-0039080

(51) Int. Cl. H04W 24/10; H04L 1/00; H04W 24/02

(52) U.S. Cl. CPC H04W 24/10; H04L 1/0009; H04W 24/02

(57) ABSTRACT

Various embodiments for techniques for intelligent channel prediction and transmission of related information in a wireless communication system are disclosed. In one embodiment, a method for a first communication device to transmit channel state information (CSI) for a specific channel to a second communication device, may comprise predicting channel state at a plurality of time points by measuring the specific channel; generating CSI for transmitting a plurality of prediction information obtained through the prediction; and transmitting the CSI to the second communication device. At least some of the plurality of prediction information occupy different overheads in the CSI.

### CROSS REFERENCE TO RELATED APPLICATION

The present application claims priority to Korean Patent Application No. 10-2023-0105760, filed on Aug. 11, 2023, and Korean Patent Application No. 10-2024-0039080, filed on Mar. 21, 2024, the entire contents of which are incorporated herein for all purposes by this reference.

### BACKGROUND

### Technical Field

The present disclosure relates to techniques for intelligent channel prediction and related information transmission in wireless communication systems. More specifically, some embodiments relate to techniques utilizing intelligent channel prediction to predict future channel states in mobile communication systems.

### Description of the Related Art

The 3rd Generation Partnership Project (3GPP), an international standards organization, is currently discussing the application of artificial intelligence (AI) and machine learning (ML) technologies, collectively referred to as “intelligent technologies,” for the New Radio (NR) air interface as a Study Item (SI) in Release 18. The objective of this study item is to establish use cases where intelligent technologies can be leveraged in the NR air interface and to assess the performance gains associated with their use in each case. Specifically, Channel State Information (CSI) Feedback

Enhancement, Beam Management, and Positioning Accuracy Enhancement have been selected as representative use cases.

In this context, methods for enhancing intelligent channel information feedback and performing life cycle management (LCM) for the corresponding intelligent models are being discussed and researched.

### SUMMARY

There may be a need for improved (e.g., more efficient) techniques for channel prediction and transmission of related information. For example, there may be a need for techniques that enhance intelligent channel information feedback and techniques that can efficiently perform Life Cycle Management (LCM) of the corresponding intelligent models.

One aspect of this disclosure provides a method for a first communication device to transmit channel state information (CSI) for a specific channel to a second communication device. The method may comprise predicting channel state at a plurality of time points by measuring the specific channel;

generating CSI for transmitting a plurality of prediction information obtained through the prediction; and transmitting the CSI to the second communication device. In some embodiments, at least some of the plurality of prediction information may occupy different overheads in the CSI.

In some embodiments, the overhead may be the number of bits representing each of the plurality of prediction information in the CSI.

In some embodiments, prediction information for a time point closest to a measurement time point may have more overhead than prediction information for a time point farthest from the measurement time point.

In some embodiments, the generating may comprise generating the CSI as codebook-based CSI, and the CSI may be generated such that prediction information for a time point closest to a measurement time point has more overhead than prediction information for a time point farthest from the measurement time point.

In some embodiments, the generating may comprise adjusting the number of bits representing at least one of an amplitude and a phase of each of the plurality of prediction information to adjust the overhead for each of the plurality of prediction information.

In some embodiments, the generating may comprise adjusting the number of NZC (non-zero coefficient) values representing each of the plurality of prediction information to adjust the overhead for each of the plurality of prediction information.

In some embodiments, the generating may comprise compressing each of the plurality of prediction information using at least one channel compression model to generate the CSI.

In some embodiments, the at least one channel compression model may comprise a plurality of channel compression models to be applied to each of the plurality of prediction information, and at least some of the plurality of channel compression models may have different compression ratios.

In some embodiments, each of the plurality of channel compression models may include at least one compression layer for compression and a layer for bit size adjustment as a last layer. In some embodiments, the at least one channel compression model may be one channel compression model, and the generating may comprise applying the one channel compression model to each of the plurality of prediction information; and adjusting the number of bits representing each of the plurality of compressed prediction information by truncating the output of the one channel compression model.

In some embodiments, the at least one channel compression model may be one channel compression model, which is a model trained to allocate more bits to prediction information closer to the measurement time point by assigning a weight to such prediction information.

In some embodiments, the method may further comprise the first communication device and the second communication device sharing a setting for the overhead of the CSI in advance through RRC (Radio Resource Control) signaling, and the generating may comprise generating the CSI according to the pre-shared setting.

In some embodiments, the transmitting may comprise transmitting the setting for the overhead of the CSI to the second communication device.

In some embodiments, the first communication device and the second communication device may correspond to user equipment and a base station belonging to a mobile communication system, respectively. In some embodiments, the specific channel may correspond to a downlink channel from the base station to the user equipment, and the CSI is CSI fed back to the base station in the mobile communication system.

Another aspect of this disclosure provides a method for a first communication device to manage a channel prediction model. The method may comprise predicting channel state at a plurality of time points based on at least some of a plurality of reference signals received from a second communication device; measuring the channel at each of the plurality of time points based on at least some of the plurality of reference signals; and storing a plurality of prediction information obtained through the prediction and a plurality of measurement information obtained through the measurement.

In some embodiments, the method may further comprise generating CSI based on the plurality of prediction information and transmitting the generated CSI to the second communication device. In some embodiments, some of the plurality of reference signals may be not used for obtaining the plurality of prediction information, but may be used for obtaining the plurality of measurement information.

In some embodiments, the method may further comprise receiving measurement configuration information and prediction configuration information from the second communication device. In some embodiments, the measurement configuration information may include information on a channel measurement window indicating the number of reference signals to be measured for prediction and a period of the channel measurement window, and the prediction configuration information may include information on a channel prediction window indicating the number of prediction information to be reported as a result of channel prediction and a period of the channel prediction window.

In some embodiments, the method may further comprise calculating a channel prediction performance indicator based on the stored plurality of prediction information and the stored plurality of measurement information; and transmitting the calculated channel prediction performance indicator to the second communication device.

In some embodiments, the method may further comprise transmitting the stored plurality of prediction information and the stored plurality of measurement information to the second communication device so that the second communication device can calculate a channel prediction performance indicator.

In some embodiments, the transmitting the stored plurality of measurement information may comprise transmitting the plurality of measurement information such that measurement information corresponding to the earliest time point among the obtained plurality of measurement information has more overhead than the measurement information corresponding to the latest time point.

In some embodiments, the method may further comprise receiving a CSI reporting configuration from the second communication device by designating only the reference signals up to a specific position from the first reference signal among the plurality of reference signals.

In some embodiments, the method may further comprise receiving a CSI reporting configuration from the second communication device by individually designating the reference signals through the value of a separate bit among the plurality of reference signals.

Another aspect of this disclosure provides a communication device comprising: A processor; one or more hardware-based transceivers; and a computer-readable storage medium containing instructions, which, in response to execution by the processor, cause the base station to perform at least one embodiment of the method of this disclosure.

Another aspect of this disclosure provides a non-transitory recording medium storing instructions readable by a processor of an electronic device, wherein the instructions cause the processor to perform embodiments of this disclosure.

This summary is provided to introduce a selection of concepts in a simplified form that are further described in the detailed description below. This summary is not intended to identify key or essential features of the claimed subject matter, nor is it intended to be used to limit the scope of the claimed subject matter. The claimed subject matter is not limited to implementations that solve any or all disadvantages noted in any part of this disclosure. In addition to the exemplary aspects, embodiments, and features described above, further aspects, embodiments, and features will become apparent from the following detailed description and accompanying drawings.

Some embodiments of this disclosure may have an effect including the following advantages. However, since it is not meant that all exemplary embodiments should include all of them, the scope of the present disclosure should not be understood as being limited thereto.

According to some embodiments, by using different compression techniques, unnecessary overhead may be prevented in situations where intelligent channel prediction technology is utilized in a cellular communication system.

According to some embodiments, techniques for obtaining a training data and monitoring performance that is necessary for the use of intelligent channel prediction technology may be provided.

### BRIEF DESCRIPTION OF THE DRAWINGS

FIG. 1 is a conceptual diagram illustrating channel prediction.

FIG. 2 is a flowchart illustrating some embodiments of channel state information (CSI) transmission according to the present disclosure.

FIG. 3 is a diagram illustrating a method for transmitting precoding matrix indicator (PMI) information for multiple time points.

FIG. 4 is a diagram illustrating the number of bits representing the amplitude of a variable, and

FIG. 5 is a diagram illustrating the number of bits representing the phase of a variable.

FIG. 6 is a diagram illustrating embodiments of applying channel information for multiple time points to each channel compression model, and FIG. 7 is a diagram illustrating embodiments of inputting channel information for multiple time points as a whole to one channel compression model.

FIG. 8 is a flowchart illustrating some embodiments of channel prediction model management according to the present disclosure.

FIG. 9 is a conceptual diagram illustrating a plurality of reference signals and prediction information.

FIG. 10 is a conceptual diagram illustrating a channel measurement window and a channel prediction window.

FIG. 11 and FIG. 12 are conceptual diagrams illustrating some embodiments of CSI reporting configuration according to the present disclosure.

FIG. 13 is a conceptual diagram illustrating some embodiments of channel prediction model monitoring according to the present disclosure.

FIG. 14 is a diagram illustrating some embodiments of performance measurement when using intelligent channel prediction and compression simultaneously.

FIG. 15 is a block diagram illustrating an internal configuration of an electronic device (e.g., a communication device) according to an embodiment of the present disclosure.

### DETAILED DESCRIPTION OF THE DISCLOSURE

Since the description of the present disclosure is merely an exemplary embodiment for structural or functional description, the scope of the present disclosure should not be construed as being limited by the exemplary embodiments described in the text. That is, since exemplary embodiments may be changed in various ways and may have various forms, it should be understood that the right scope of the present disclosure includes equivalents that can realize the technical idea. In addition, the objectives or effects presented in the present disclosure may not mean that a specific exemplary embodiment should include all or only such effects, so the right scope of the present disclosure should not be understood as being limited thereto.

Meanwhile, the meaning of the terms described in the present disclosure should be understood as follows.

Terms such as “first”, “second”, and the like are intended to distinguish one component from another component, and the scope of rights should not be limited by these terms. For example, a first component may be referred to as a second component, and similarly, a second component may also be referred to as a first component.

When a component is referred to as being “connected” to another component, it may be directly connected to the other component, but it should be understood that other components may exist in the middle. On the other hand, when a component is referred to as being “directly connected” to another component, it should be understood that no other component exists in the middle. Meanwhile, other expressions describing the relationship between components, such as “between” and “immediately between” or “neighboring to” and “directly neighboring to”, should be interpreted in the same way.

Singular expressions should be understood to include plural expressions unless the context clearly indicates otherwise, and terms such as “include” or “have” are intended to designate the existence of features, numbers, steps, actions, components, parts, or combinations thereof, and should be understood not to preclude the possibilities of the existence or addition of one or more other features or numbers, steps, actions, components, parts, or combinations thereof.

In each step, identification codes (e.g., a, b, c, etc.) may be used for the convenience of explanation, and identification codes may not describe the order of each step, and each step may occur differently from the specified order unless a specific order is explicitly stated in the context. That is, each step may occur in the same order as the specified order, may be performed substantially simultaneously, or may be performed in the opposite order.

Channel State Information (CSI) feedback refers to the process in mobile communication systems where a user equipment (UE) reports CSI to the base station, enabling the base station to apply transmission techniques such as Multiple Input Multiple Output (MIMO) or precoding. The 5G NR standard defined by 3GPP supports feedback information such as Channel Quality Indicator (CQI), Precoding Matrix Indicator (PMI), and Rank Indicator (RI) in relation to CSI feedback methods. In NR systems, discussions are ongoing to improve CSI feedback techniques to effectively support transmission techniques such as Multi-user MIMO (MU-MIMO).

One research direction for incorporating intelligent technologies into channel information feedback involves discussions on channel prediction (CSI prediction), which estimates future channel information.

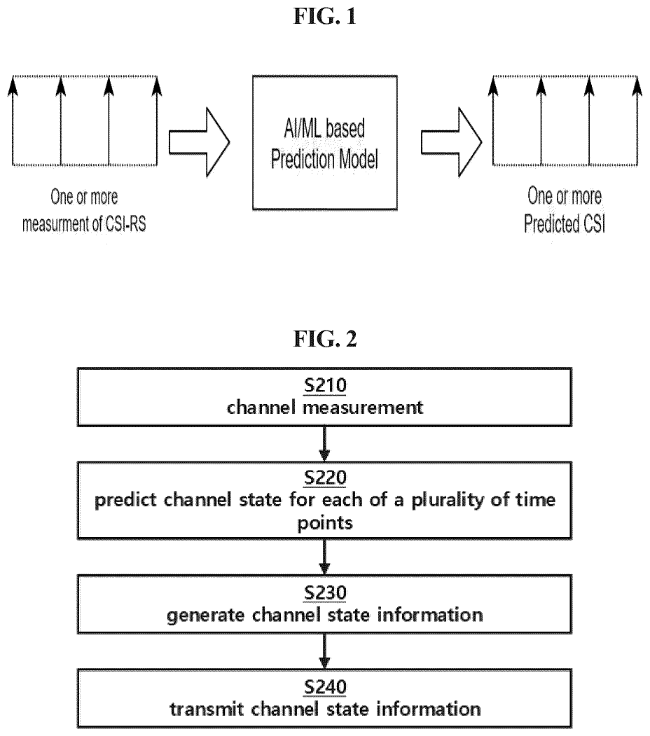

FIG. 1 is a conceptual diagram illustrating channel prediction. Referring to FIG. 1, CSI prediction can be defined as the process of inputting the measurement results of one or more CSI-RS signals transmitted by the base station into a predefined prediction model (e.g., the AI/ML based Prediction Model in FIG. 1) to infer one or more CSI outputs. The UE uses the prediction model to generate channel state information for one or more time points and includes it in a single CSI report for transmission.

Meanwhile, since intelligent technologies are based on training data, life cycle management (LCM) for the creation and maintenance of intelligent models according to changes in the training data needs to be performed. Therefore, if functions based on intelligent technologies are to be applied in mobile communication systems consisting of base stations and/or UEs, as in the use cases mentioned above, the mobile communication systems should be able to support LCM. In this regard, 3GPP is discussing the detailed steps of the LCM process, including Data Collection, Model Training, Model Inference, Model Deployment, Model Activation, Model Deactivation, Model Selection, Model Monitoring, and Model Transfer. For example, in a mobile communication system, a specific intelligent model may be created through model training based on data collection, then go through model deployment and model activation processes, operate through model inference using the model, and be managed through the model monitoring process.

FIG. 2 is a flowchart illustrating some embodiments of channel state information (CSI) transmission according to the present disclosure.

In some embodiments of FIG. 2, the method includes the first communication device transmitting channel state information for a specific channel to the second communication device.

In some embodiments, the first and second communication devices may be devices capable of communicating with each other in a wireless communication system. In some embodiments, the wireless communication system may include more communication devices in addition to the first and second communication devices.

In some embodiments, the wireless communication system may be a mobile communication system including each of the first and second communication devices as a UE and a base station, respectively. In other embodiments, the wireless communication system may be a system other than a mobile communication system (e.g., cellular communication system). For example, the wireless communication system may be a Wi-Fi communication system including a wireless station and a wireless access point.

Hereinafter, several embodiments may be described mainly with respect to a downlink channel in a mobile communication system comprising a UE and a base station for convenience, but those skilled in the art will understand that the technology of the present disclosure can be easily applied, implemented, or reproduced in other systems (e.g., an uplink channel or other wireless communication systems) through these descriptions.

In some embodiments, as illustrated in FIG. 2, the first communication device may measure a specific channel (S210).

In some embodiments, as illustrated in FIG. 2, the first communication device may predict the channel state for each of a plurality of time points based on the measurement result in block S210 (S220).

In some embodiments, as illustrated in FIG. 2, the first communication device may generate CSI for transmitting a plurality of prediction information obtained through the prediction in block S220 (S230).

In some embodiments, as illustrated in FIG. 2, the first communication device may transmit the CSI generated in block S230 to the second communication device (S240).

In some embodiments, at least some of the plurality of prediction information may occupy different overheads (e.g., the number of bits representing each of the plurality of prediction information in the CSI) in the CSI. For example, the prediction information for a time point closest to the measurement time point may have more overhead than the prediction information for a time point farthest from the measurement time point.

Channel prediction predicts the channel state in the future after a certain time based on the measurement results of signals from previous times. In general channel prediction models, the difference between the actual (ground-truth) channel and the predicted channel increases as the prediction time elapses further from the current time point. In this case, the channel prediction value for a time point closer to the current time point may have a more accurate value than the channel prediction value for later time points. The reason for this result is that the operation of the channel prediction model uses data from previous time points to estimate the trend (direction) in which the future result value is expected to occur. In general, the predicted value for a future time point based on the estimated trend is likely to match the actual value more closely if the future time point is closer to the prediction time point (e.g., the current time point). However, as the future time point gets further from the prediction time point, the difference between the predicted value baded on the estimated trend and the actual value widens.

The UE may transmit information about the channel state at a future time point estimated through channel prediction to the base station. In this case, if the channel states at multiple time points have been predicted through channel prediction, the corresponding information can be included in one feedback and transmitted. In other words, channel information for one or more time points can be configured as one channel prediction-based feedback. In the process of transmitting the predicted channel information to the base station, a compression process may be performed to reduce overhead. In the existing 3GPP standard, a codebook-based compression method has been used. In addition, AI/ML-based intelligent technology may also be used for channel compression. In this process, generally, more overhead (e.g., the number of bits) may be required to express precise channel prediction values.

Therefore, in some embodiments, when expressing channel prediction values for closer time points where relatively accurate values can be estimated in the channel prediction process, sufficient overhead may be used to transmit these to the base station, and fewer overheads may be used for expressing channel prediction values for more distant time points. In other words, in the process of transmitting CSI, the prediction information included in the CSI may have different levels of compression (or quantization levels) or priorities depending on the prediction target time (future time point). This prevents unnecessary overhead waste when the UE transmits prediction information to the base station.

In some embodiments, in block S230, the first communication device may generate the CSI as codebook-based CSI, and the CSI may be generated such that prediction information for a time point closest to a measurement time point has more overhead than prediction information for a time point farthest from the measurement time point. For example, the first communication device may adjust the number of bits representing at least one of an amplitude and a phase of each of the plurality of prediction information to adjust the overhead for each of the plurality of prediction information. In another example, the first communication device may adjust the number of NZC (non-zero coefficient) values representing each of the plurality of prediction information to adjust the overhead for each of the plurality of prediction information.

Some embodiments include techniques where the channel information transmission between the UE and the base station is performed in the form of an existing 3GPP codebook but with differentiated compression levels. In the codebook-based method, channel information is converted into PMI (Precoding Matrix Indicator) information for precoding and transmitted to the base station. Specifically, the 3GPP NR system supports two types of codebooks for transmitting PMI information, each named TYPE 1 codebook and TYPE 2 codebook.

The TYPE 1 codebook represents a beam group as an oversampled DFT matrix and has a structure of selecting one of the beams and transmitting it.

On the other hand, the TYPE 2 codebook has a structure of selecting a plurality of beams and transmitting information in the form of a linear combination of the selected beams.

Enhanced Type2 codebook (eType2) performs additional compression in the frequency domain to address the overhead issue caused by the increased number of coefficients that Type2 codebook must include. This method reduces overhead by transmitting only the NZC (Non-Zero Coefficient) values corresponding to specific selected positions, rather than all variables represented by the selected beams and frequency bands.

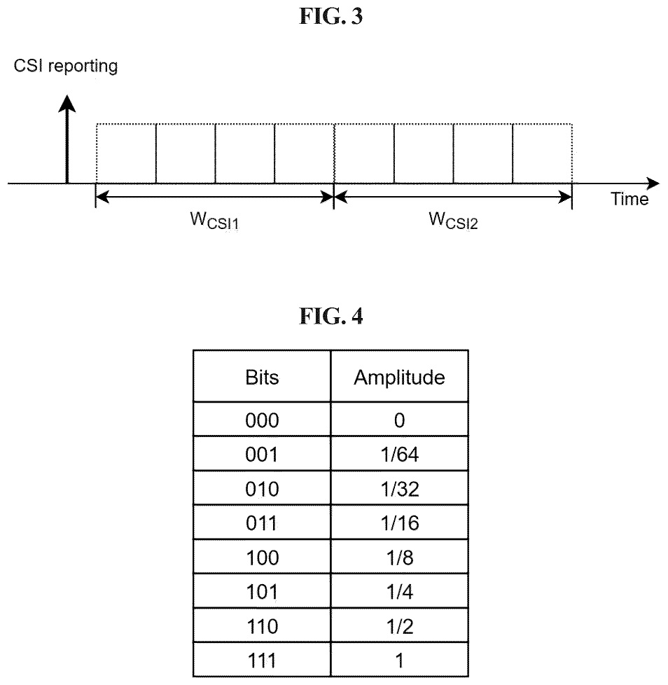

FIG. 3 is a diagram illustrating a method for transmitting precoding matrix indicator (PMI) information for multiple time points.

In some embodiments, unlike conventional CSI reporting methods that include PMI information for only one time point, the first communication device may report CSI by including information for multiple time points within a single PMI using compression in the Doppler domain or time domain. For example, as illustrated in FIG. 3, two PMIs, W_CSI1 and W_CSI2, may be included in a CSI report. In this case, W_CSI1 and W_CSI2 may be compressed and transmitted to represent PMI values corresponding to four time points each.

In the example of FIG. 3, if W_CSI1 and W_CSI2 are estimated using a channel prediction method, different compression levels can be set for the two PMIs. For example, the compression levels can be set differently by adjusting the number of bits representing the amplitude and phase of the selected variable.

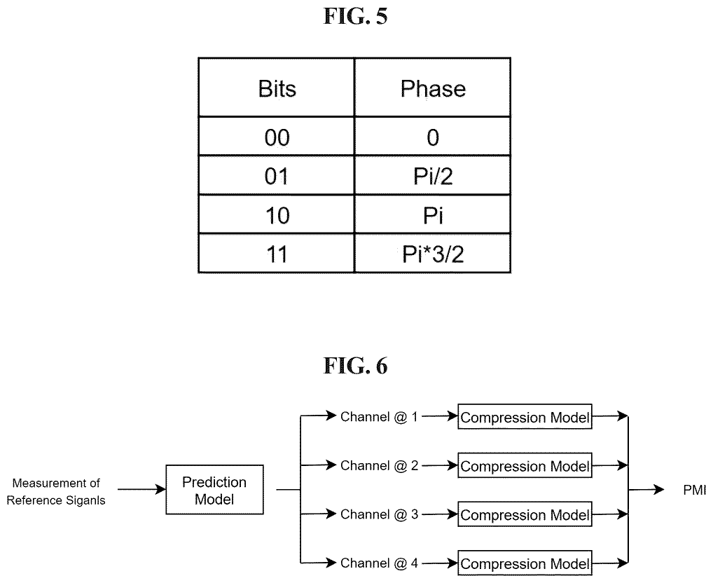

FIG. 4 is a diagram illustrating the number of bits representing the amplitude of a variable, and FIG. 5 is a diagram illustrating the number of bits representing the phase of a variable.

Generally, the amplitude is represented as a ratio to the strongest resource, and using more bits allows for finer comparison of the amplitudes. That is, FIG. 4 illustrates an example of using 3 bits to represent the amplitude compared to the strongest resource power.

Similarly, the phase can be represented by dividing the angle equally according to the number of bits available. That is, FIG. 5 illustrates an example of using 2 bits to represent the phase in uniformly divided angles.

Therefore, if the number of bits to be expressed is reduced, the number of cases that can be expressed may be reduced. However, since W_CSI2, which includes the prediction result for a relatively later time point, has lower accuracy in the channel prediction process, considering this advantage, in some embodiments, the number of bits representing the prediction result for the later time point may be less than the number of bits representing the prediction result for the earlier time point.

In some embodiments, as a method of setting different compression levels, the first communication device may differentially apply the number of NZCs, which are variables to be transmitted. Through RRC signaling, the number of NZCs that can be included in the first layer and the number of NZCs that can be included in the entire layer can be set for each PMI information. For example, in the example of FIG. 2, the wireless communication system may be configured to include a larger number of NZCs in W_CSI1 and a smaller number of NZCs in W_CSI2.

In some embodiments, in block S230, the first communication device may compress each of the plurality of prediction information using at least one channel compression model to generate the CSI.

In some embodiments, the at least one channel compression model may comprise a plurality of channel compression models to be applied to each of the plurality of prediction information, and at least some of the plurality of channel compression models may have different compression ratios. For example, each of the plurality of channel compression models may include at least one compression layer for compression and a layer for bit size adjustment as a last layer. In another example, the at least one channel compression model may be one channel compression model, and in block S230, the first communication device may apply the one channel compression model to each of the plurality of prediction information and adjust the number of bits representing each of the plurality of compressed prediction information by truncating the output of the one channel compression model. In yet another example, the at least one channel compression model may be one channel compression model, which is a model trained to allocate more bits to prediction information closer to the measurement time point by assigning a weight to such prediction information.

FIG. 6 is a diagram illustrating embodiments of applying channel information for multiple time points to each channel compression model, and FIG. 7 is a diagram illustrating embodiments of inputting channel information for multiple time points as a whole to one channel compression model.

In some embodiments, as illustrated in FIG. 6, the channel information for multiple time points generated through channel prediction may be applied to the same channel compression model at each time point and compressed to be transmitted to the base station. In this case, the compressed bits generated through each compression model may be adjusted through settings. One example of a method for adjusting the compressed bits is changing the compression ratio. In this case, the channel information of the earlier time point may be set to increase the number of compressed bits by reducing the compression ratio, and the channel information of the later time point may be set to reduce the number of compressed bits by increasing the compression ratio. Another example of a method for adjusting the compressed bits is adding a bit size conversion layer at the very last layer of the same model. Yet another example of adjusting the compressed bits is using different intelligent compression models with different amounts of final compressed bits. A further example of a method for adjusting the compressed bits is truncating the compressed bits generated by using the same intelligent compression model. In this case, to match the predetermined number of compressed bits, some compressed bits may be cut off, and only the remaining portion may be transmitted to the base station.

In some embodiments, as illustrated in FIG. 7, the channel information for multiple time points generated through channel prediction may be input as a whole to one channel information compression model for compression, and the compressed result may be transmitted to the base station. In this case, all channel prediction information is included in the bits output from the compression model. Therefore, it is generally impossible to explicitly increase the information of a close time point and reduce the information of a distant time point. To address this, in some embodiments, the wireless communication system may use a method of assigning different weights to the channel information for closer (i.e., earlier) and farther (i.e., later) time points during the training process of the compression model so that the bit size adjustment operation is included in the intelligent model.

In order to perform a differentiated information representation method according to the channel prediction time point, information the differentiated information representation may need to be shared in advance between the first communication device and the second communication device.

In some embodiments, the method may further comprise the first communication device and the second communication device may perform an operation (hereinafter, setting sharing operation) of sharing a setting for the overhead of the CSI in advance through RRC (Radio Resource Control) signaling, and the first communication device may generate the CSI in block S230 according to the pre-shared setting.

This setting sharing operation is not shown in FIG. 2, but may be performed at least before block S230. For example, the setting can be used multiple times (i.e., used for CSI transmission) through one setting sharing operation. An example of the setting sharing target is the allowable number of NZCs mentioned above. For example, the allowable number of NZCs can be set in advance through RRC signaling for both high accuracy and low accuracy, and one of the two settings can be selected and used in the process of transmitting intelligent channel prediction information.

In some embodiments, the first communication device may transmit the setting for the overhead of the CSI to the second communication device in block S230. In this case, the first communication device may directly determine the compression ratio according to the predicted channel information and transmit it to the second communication device by including it in the uplink transmission process (e.g., PUCCH or PUSCH). For example, if the first communication device transmits the compressed bit information used for each time point to the base station together with the CSI, the base station may restore the compressed CSI based on the received information. In another example, the first communication device may transmit not only the compression ratio information as overhead setting information but also direct CSI payload size information that can determine the CSI feedback size. In yet another example, if the first communication device uses a plurality of intelligent compression models in the channel compression process, only the identifier of the corresponding model may be transmitted to the second communication device, and the second communication device may recognize the size of the compressed bits output from the corresponding model and the compressed information based on the received identifier.

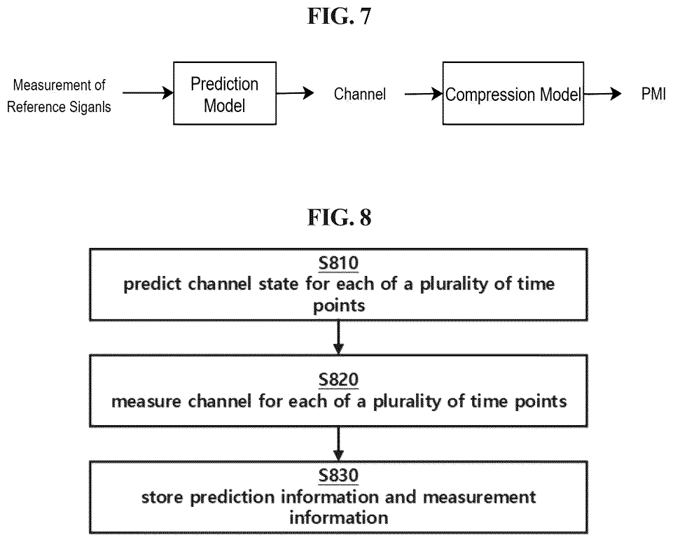

FIG. 8 is a flowchart illustrating some embodiments of channel prediction model management according to the present disclosure.

In some embodiments, as illustrated in FIG. 8, the first communication device may predict channel state at a plurality of time points based on at least some of a plurality of reference signals received from a second communication device (S810).

In some embodiments, as illustrated in FIG. 8, the first communication device may measure the channel at each of the plurality of time points based on at least some of the plurality of reference signals (S820).

In some embodiments, as illustrated in FIG. 8, the first communication device may store a plurality of prediction information obtained in block S810 and a plurality of measurement information obtained in block S820 (S830).

In some embodiments, the first communication device may generate CSI based on the plurality of prediction information obtained in block S810 and transmit the generated CSI to the second communication device (CSI transmission operation). This CSI transmission operation may be performed after block S810.

In some embodiments, some of the plurality of reference signals may be not used for obtaining the plurality of prediction information, but may be used for obtaining the plurality of measurement information.

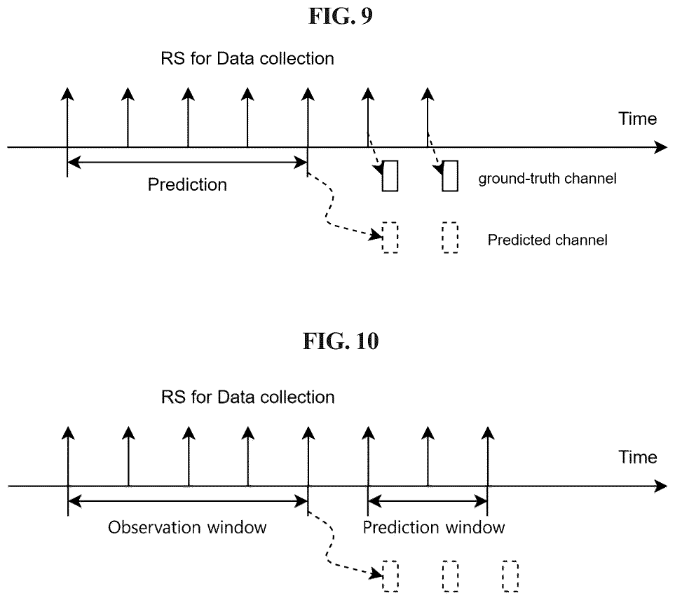

FIG. 9 is a conceptual diagram illustrating a plurality of reference signals and prediction information.

To train an intelligent channel prediction model, data corresponding to the input and output is required. While the training process may occur offline, the data collection operation for obtaining information from the actual channel environment may occur between the UE and the base station. For example, to compare previous measurement information (i.e., reference signal measurement information) used as input for channel prediction and the prediction results with future actual result values (ground-truth), continuous reference signal transmission may be necessary, as illustrated in FIG. 9. For instance, the first five reference signals in FIG. 9 may be used for the prediction information acquisition block (S810) to obtain prediction information for the last two time points, and the last two reference signals in FIG. 9 may be used for the measurement information acquisition block (S820) to obtain ground-truth channel information used to compare the prediction information for the corresponding two time points.

The process of acquiring training information for intelligent channel prediction may be performed using a general channel measurement process between the base station and the UE, but it may also be performed solely for the purpose of collecting separate training data for channel prediction.

In some embodiments, the first communication device may perform an operation (setting information receiving operation) of receiving measurement configuration information and prediction configuration information from the second communication device. For example, this setting information receiving operation may be performed before block S810.

In some embodiments, the measurement configuration information may include information on a channel measurement window indicating the number of reference signals to be measured for prediction and a period of the channel measurement window.

In some embodiments, the prediction configuration information may include information on a channel prediction window indicating the number of prediction information to be reported as a result of channel prediction and a period of the channel prediction window.

FIG. 10 is a conceptual diagram illustrating a channel measurement window and a channel prediction window.

For example, to enable the first communication device to collect data for training, the second communication device may additionally transmit, as illustrated in FIG. 10, channel measurement window information (number of reference signals to be used for channel prediction) and its period information; and channel prediction window information (number of channel time points predicted as a result of channel prediction) and its period information to the first communication device. In this case, the first communication device may perform intelligent channel prediction according to the configuration information received from the second communication device and store data for training.

Additionally, even if the first communication device has measured the channel using the received reference signals, a signal to inform the first communication device separately may be required if there is no need to transmit CSI information feedback to the base station or if it should not be transmitted. This is because providing feedback on all received reference signals may significantly increase overhead.

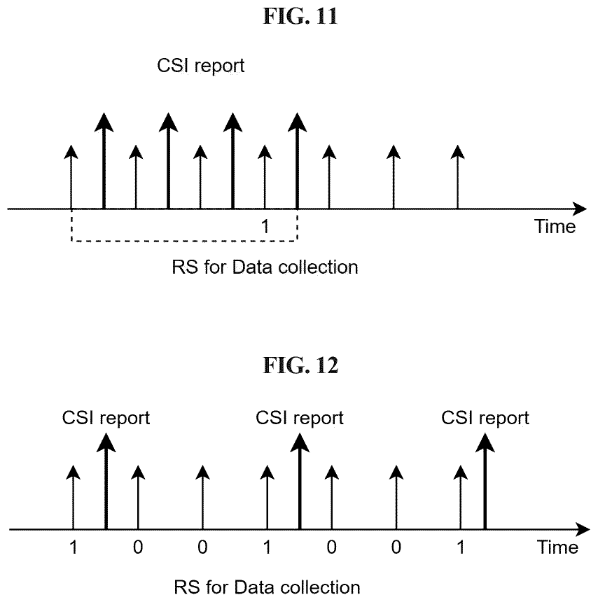

FIG. 11 and FIG. 12 are conceptual diagrams illustrating some embodiments of CSI reporting configuration according to the present disclosure.

In some embodiments, as illustrated in FIG. 11, the second communication device may provide a CSI reporting configuration to the first communication device by designating only the reference signals up to a specific position from the first reference signal among the plurality of reference signals.

In some embodiments, as illustrated in FIG. 12, the second communication device may provide a CSI reporting configuration to the first communication device by individually designating the reference signals through the value of a separate bit among the plurality of reference signals.

In some embodiments, contrary to the embodiments of FIG. 11 and FIG. 12, the CSI reporting configuration may be provided to the first communication device in a way that CSI feedback is not performed for the corresponding reference signals.

When an intelligent model operates, model monitoring operation may be performed according to the life cycle management. The model monitoring operation may include a process of calculating and transmitting a performance indicator (e.g., Intermediate Key Performance Indicator) to determine the performance of the intelligent model. The continuous reference signal transmission described above may be used in this process. The model monitoring operation of the intelligent channel prediction model may be performed in the first communication device or the second communication device.

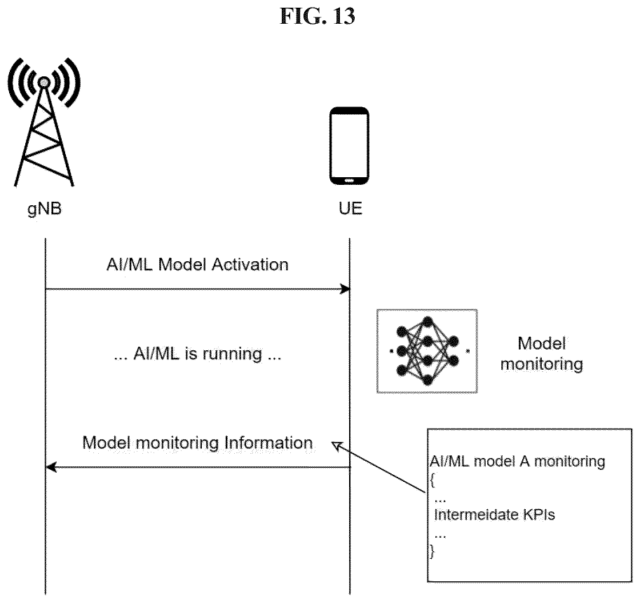

FIG. 13 is a conceptual diagram illustrating some embodiments of channel prediction model monitoring according to the present disclosure.

In some embodiments, the first communication device may calculate a channel prediction performance indicator based on the plurality of prediction information and measurement information stored in block S830, and transmit the calculated channel prediction performance indicator to the second communication device.

For example, as illustrated in FIG. 13, when the model monitoring process is performed in the first communication device (UE), the UE may calculate a key performance indicator (KPI) by comparing the channel value estimated through channel prediction (i.e., the prediction information for each of the plurality of time points) with the value obtained through actual measurement (i.e., the measurement information for each of the corresponding time points), and transmit the calculated KPI value to the second communication device (base station).

In some embodiments, the first communication device may transmit the plurality of prediction information and measurement information stored in block S830 to the second communication device so that the second communication device can calculate a channel prediction performance indicator. In some embodiments, the first communication device may transmit the plurality of measurement information such that measurement information corresponding to the earliest time point among the obtained plurality of measurement information has more overhead than the measurement information corresponding to the latest time point.

In this way, when the model monitoring process is performed in the second communication device (base station), the UE may transmit the channel value estimated through channel prediction and the ground-truth channel information measured by the UE to the base station, and the base station, upon receiving them, may calculate the KPI to evaluate the performance of the intelligent operation.

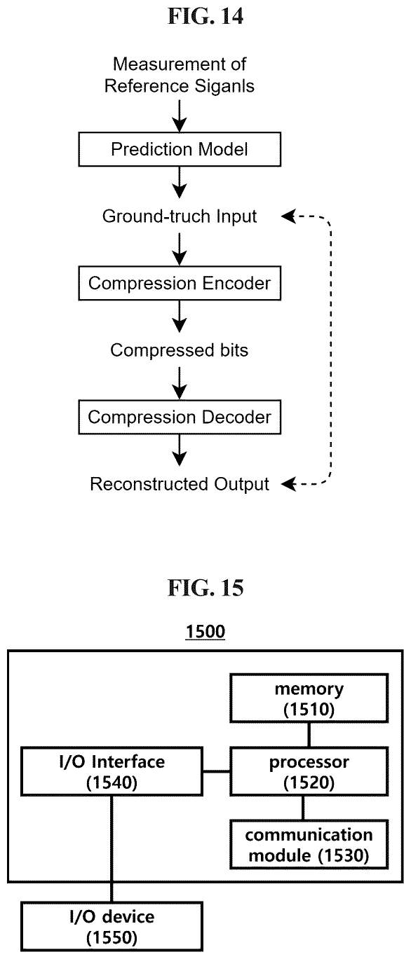

FIG. 14 is a diagram illustrating some embodiments of performance measurement when using intelligent channel prediction and compression simultaneously.

As illustrated in FIG. 14, when intelligent channel prediction and intelligent channel compression are performed simultaneously, channel information predicted through intelligent channel prediction (which corresponds to ground-truth from the perspective of channel compression) may be transmitted from the UE to the base station for the purpose of measuring the performance of intelligent channel compression.

Generally, as illustrated in FIG. 14, the intelligent channel compression model may consist of an encoder operating at the UE and a decoder operating at the base station. In this configuration, it may be necessary to transmit the channel prediction values, which were used as input for the compression model, from the UE to the base station to evaluate the performance of the channel compression model at the base station.

Therefore, the channel information extracted from multiple time points generated in channel prediction needs to be transmitted from the UE to the base station, but transmitting all channel information may cause a lot of overhead. To reduce overhead, several embodiments can be employed, such as reducing a 32-bit float to an 8-bit integer, using quantization (e.g., uniform quantization) to reduce channel information data, or using codebook-based quantization (e.g., eType II codebook-based quantization) as used in existing 3GPP standards to compress the channel information data.

As described above, the channel prediction information of closer time points may be more accurate than the channel prediction information of distant time points. Therefore, even when transmitting ground-truth values by the UE to the base station, the ground-truth values of closer time points may be transmitted using a finer quantization method using more bits, and the ground-truth values of distant time points may be transmitted using a coarser quantization method using relatively fewer bits.

FIG. 15 is a block diagram illustrating an internal configuration of an electronic device (e.g., a communication device) according to an embodiment of the present disclosure. As shown in FIG. 15, the electronic device (1500) may include a memory (1510), a processor (1520), a communication module (1530), and an input/output interface (1540).

The memory (1510) may be a computer-readable recording medium and may include a RAM (random access memory), a ROM (read only memory), and a non-volatile mass storage device such as a disk drive. Here, the ROM and the non-volatile mass storage devices may be included as separate permanent storage devices apart from the memory (1510). Additionally, the memory (1510) may store an operating system and at least one program code (e.g., a computer program stored on the recording medium included in the electronic device (1500) to control the electronic device (1500) to perform methods according to embodiments of the present disclosure). These software components may be loaded from a computer-readable recording medium separate from the memory (1510). This separate computer-readable recording medium may include floppy drives, disks, tapes, DVD/CD-ROM drives, memory cards, and other computer-readable recording media. In other embodiments, the software components may be loaded into the memory (1510) via the communication module (1530) instead of a computer-readable recording medium.

The processor (1520) may be configured to process instructions of a computer program by performing basic arithmetic, logic, and input/output operations. The instructions may be provided to the processor (1520) by the memory (1510) or the communication module (1530). For example, the processor (1520) may be configured to execute the instructions received according to the program code loaded into the memory (1510). As a more specific example, the processor (1520) can sequentially execute instructions according to the code of a computer program loaded in the memory (1510) to perform beam configuration and/or RIS control according to the embodiments of the present disclosure.

The communication module (1530) may provide functions for communicating with other physical devices over an actual computer network. For example, while the processor (1520) of the electronic device (1500) performs part of the process of the present embodiment, another physical device in the network (e.g., another computing system not shown) can perform the remaining process, and the processing results may be exchanged via the computer network and the communication module (1530) to perform the embodiments of the present disclosure.

The input/output interface (1540) may serve as a means for interfacing with input/output devices (1550). For example, input devices in the input/output devices (1550) may include devices such as a keyboard or a mouse, and output devices may include devices such as a display or speakers. In FIG. 15, the input/output devices (1550) are represented as separate devices from the electronic device (1500), but in some embodiments, the electronic device (1500) may be implemented to include the input/output devices (1550).

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

What is claimed is:

1. A method for a first communication device to transmit channel state information (CSI) for a specific channel to a second communication device, the method comprising:
predicting channel state at a plurality of time points by measuring the specific channel;
generating CSI for transmitting a plurality of prediction information obtained through the prediction; and
transmitting the CSI to the second communication device,
wherein at least some of the plurality of prediction information occupy different overheads in the CSI.

2. The method of claim 1, wherein the overhead is the number of bits representing each of the plurality of prediction information in the CSI.

3. The method of claim 1, wherein prediction information for a time point closest to a measurement time point has more overhead than prediction information for a time point farthest from the measurement time point.

4. The method of claim 1, wherein the generating comprises generating the CSI as codebook-based CSI, wherein the CSI is generated such that prediction information for a time point closest to a measurement time point has more overhead than prediction information for a time point farthest from the measurement time point.

5. The method of claim 4, wherein the generating comprises adjusting the number of bits representing at least one of an amplitude and a phase of each of the plurality of prediction information to adjust the overhead for each of the plurality of prediction information.

6. The method of claim 4, wherein the generating comprises adjusting the number of NZC (non-zero coefficient) values representing each of the plurality of prediction information to adjust the overhead for each of the plurality of prediction information.

7. The method of claim 1, wherein the generating comprises compressing each of the plurality of prediction information using at least one channel compression model to generate the CSI.

8. The method of claim 7, wherein the at least one channel compression model comprises a plurality of channel compression models to be applied to each of the plurality of prediction information, and at least some of the plurality of channel compression models have different compression ratios.

9. The method of claim 8, wherein each of the plurality of channel compression models includes at least one compression layer for compression and a layer for bit size adjustment as a last layer.

10. The method of claim 8, wherein the at least one channel compression model is one channel compression model, and the generating comprises applying the one channel compression model to each of the plurality of prediction information; and adjusting the number of bits representing each of the plurality of compressed prediction information by truncating the output of the one channel compression model.

11. The method of claim 7, wherein the at least one channel compression model is one channel compression model, which is a model trained to allocate more bits to prediction information closer to the measurement time point by assigning a weight to such prediction information.

12. The method of claim 1, further comprising the first communication device and the second communication device sharing a setting for the overhead of the CSI in advance through RRC (Radio Resource Control) signaling, wherein the generating comprises generating the CSI according to the pre-shared setting.

13. The method of claim 1, wherein the transmitting comprises transmitting the setting for the overhead of the CSI to the second communication device.

14. The method of claim 1, wherein the first communication device and the second communication device correspond to user equipment and a base station belonging to a mobile communication system, respectively, wherein the specific channel corresponds to a downlink channel from the base station to the user equipment, and the CSI is CSI fed back to the base station in the mobile communication system.

15. A method for a first communication device to manage a channel prediction model, the method comprising:
predicting channel state at a plurality of time points based on at least some of a plurality of reference signals received from a second communication device;
measuring the channel at each of the plurality of time points based on at least some of the plurality of reference signals; and
storing a plurality of prediction information obtained through the prediction and a plurality of measurement information obtained through the measurement.

16. The method of claim 15, further comprising generating CSI based on the plurality of prediction information and transmitting the generated CSI to the second communication device, wherein some of the plurality of reference signals are not used for obtaining the plurality of prediction information, but are used for obtaining the plurality of measurement information.

17. The method of claim 15, further comprising receiving measurement configuration information and prediction configuration information from the second communication device, wherein the measurement configuration information includes information on a channel measurement window indicating the number of reference signals to be measured for prediction and a period of the channel measurement window, and the prediction configuration information includes information on a channel prediction window indicating the number of prediction information to be reported as a result of channel prediction and a period of the channel prediction window.

18. The method of claim 15, further comprising calculating a channel prediction performance indicator based on the stored plurality of prediction information and the stored plurality of measurement information; and transmitting the calculated channel prediction performance indicator to the second communication device.

19. The method of claim 15, further comprising transmitting the stored plurality of prediction information and the stored plurality of measurement information to the second communication device so that the second communication device can calculate a channel prediction performance indicator.

20. The method of claim 19, wherein the transmitting the stored plurality of measurement information comprises transmitting the plurality of measurement information such that measurement information corresponding to the earliest time point among the obtained plurality of measurement information has more overhead than the measurement information corresponding to the latest time point.
